(19) United States
(12) Patent Application Publication
(10) Pub. No.: US 2025/0131051 A1
(43) Pub. Date: Apr. 24, 2025

(54) EATCHAT MOBILE APPLICATION THAT CONNECTS PEOPLE WITHIN A 50-MILE RADIUS THROUGH A SHARED FOOD CRAVINGS

(71) Applicant: PRINCE ANTWI, LAWRENCEVILLE, GA (US)

(72) Inventor: PRINCE ANTWI, LAWRENCEVILLE, GA (US)

(21) Appl. No.: 18/382,168

(22) Filed: Oct. 20, 2023

(51) Int. Cl. G06F 16/9535; G06Q 50/00

(52) U.S. Cl. CPC G06F 16/9535; G06Q 50/01

(57) ABSTRACT

A novel approach of introducing a cutting-edge mobile application that is designed to revolutionize the way people satisfy their food cravings. With this app, users can post their specific food cravings, including the type of cuisine, dish, and even specific ingredients. The advanced algorithm of the app then matches the user's post with other users who have similar preferences based on age, gender, and located within a 50-mile radius. Users can then connect with each other via the app's chat feature and discuss their cravings in more detail. The app also allows users to explore new restaurants and cuisines by searching for places that serve the specific dishes they're craving. Users can even rate and review the restaurants they visit, sharing their experiences with other foodies on the app. The app is designed to be user-friendly and intuitive, with a sleek and modern interface that makes it easy to navigate. Users have complete control over their profiles and can adjust their preferences and settings at any time. With this app, foodies can satisfy their cravings and connect with like-minded individuals who share their passion for food and exploration.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present embodiments concern methods, apparatus, and systems that are centered around an intelligent food and community management system. The system at hand provides a user-friendly platform that permits individuals to engage with others within a 50-mile radius based on shared food cravings. The service notably emphasizes the use of a food matching algorithm that is designed to connect individuals with similar dietary preferences, thereby fostering an environment of shared interest and community building. The system's unique approach to food management and social networking has the potential to significantly improve the lives of users by promoting healthy eating habits and facilitating the formation of meaningful connections within the community.

### Description of the Related Art

As computers and electronic mobile devices become more connected and more capable, new opportunities for innovative ways of creating an efficient food management system emerge.

Multiple solutions have been presented in prior art in regarding efficient food manufacturing, delivery, and management systems. For instance, a U.S. Pat. No. 4,797,818A food order/delivery system discusses a computerized order/delivery system for use in the food service industry includes a central computer that accepts customer food orders and based on a customer identifier, automatically selects the store that is to prepare the food and transmits the required information to that location.

A Food Delivery Service bearing US patent 2,015,0088779A1 aims to provide an integrated real-time, customer-company process that materially improves the end-to-end customer experience for delivery of products and services. The invention enables more efficient management of a company's supply-demand relationship, unit costs, and return on investment. Example embodiments are directed to an inter-related, customer-company management process for a food delivery business. A process on an intelligent, processor-based platform provides an improved end-to-end customer experience, for example, by reducing wait times and using convenient payment options so that customer does not need to handle money. The process further enables a food truck operator to manage the business more efficiently, both at a single site and across multiple sites. There is a substantial, real-time interdependency between the customers and the food truck operator. The process provides ongoing Just-in-Time order status information to customers and ongoing Just-in-Time operating and cooking instructions to the food truck operator.

A US patent 2,012,0239683A1 relates to food related social networking website. A food-related website utilizes a method to recommend to a user food-related results based on a criterion entered by the user. The method can match criteria in food-related results to make suggestions to the user. The method can match criteria in other user's accounts to recommend food-related results that match the criterion and that the other user recommends. Food-related result can be a food, ingredient, recipe, meal, restaurant, drink, or the like.

A US patent 2,011,0208617A1 relates to a system and method for locality and user preference-based food recommendations. The system and methods for generating and presenting recommendations of places to eat based on a user's preferences and profile. A set of preferences and ratings are maintained by multiple users which are used to filter and generate rating estimations. Preferences and ratings of other users with similar preference profiles are used to increase or decrease the recommendations. The location and preferences of multiple users can also be compared to provide eating recommendations for a group of users. The recommendations and ratings can be drilled down to specific menu item for determining recommendations on the full meal or a specific item. The system can also be used by the restaurant owner to identify potential customers, target marketing messages, identify problems with the menu or staff, and improve the impression and quality of the restaurant and food.

A US patent 2,012,0030193A1 relates to method and system for connecting users. A method and system for connecting users via a matrix/mesh/grid/graph of intermediate relationship routing (FIG. 3, element 50), comprising creating a collective business incentive awareness through a multi layered (per service) charge system defined by the users themselves, while utilizing and harnessing the power of P2P (Peer-to-Peer)/Client-Server, Collaboration tools, 3D/2D GUI (3d bubble/Birdseye view) navigation interfaces for effectively presenting a large volume of information to users. The system allows users (100,110) to focus on specific groups or individuals in a secure, private and anonymous environment.

A U.S. Pat. No. 9,733,811B2 relates to matching process system and method. The method for profile matching includes receiving a plurality of user profiles, each user profile comprising traits of a respective user. The method includes receiving a preference indication for a first user profile of the plurality of user profiles. The method also includes determining a potential match user profile of the plurality of user profiles based on the preference indication for the first user profile. The method also includes presenting the potential match user profile to a second user.

A multi-platform network for providing ordering services bearing US patent 2,009,0089183A1 relates to a food ordering system may receive, from a user, a request to place a food order, identify the user, identify a type of user device used by the user to place the request, identify a user interface client that is tailored to the type of the user device, receive, via the user interface client, input from the user to establish the food order, and provide the food order to a restaurant.

Over the years, there have been various advancements in multiple systems as evidenced in the prior art. These advancements have been made with the aim of improving the functionality of the systems and enhancing their overall performance. Despite these efforts, the utility of these systems is yet to be fully tested and evaluated. It is therefore important to carry out further research and development to determine the effectiveness and suitability of these systems for their intended purposes.

The current invention proposes a unique system with a standalone way of supporting, collating, handling, and facilitating food connection and community formation. The proposed mobile application allows people to connect within a 50-mile radius through shared food cravings.

None of the previous inventions and patents, taken either singly or in combination, is seen to describe the instant invention as claimed. Hence, the inventor of the present invention proposes to resolve and surmount existent technical difficulties to eliminate the shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the problems of the prior art and/or to provide the relevant public with a suitable alternative thereto having relative advantages.

It is a general object of the present invention to provide an improved form of system that provides an enhanced eating experience where a user can connect with another user having same eating preferences.

It is another object to provide an improved, convenient, safe and effective way to solve the problem of loneliness and going on dates or restaurants alone. When a user posts their food cravings, other users get notified and can chat and meet up to go get the food they are craving together.

It is another object to disclose a method to automatically generate a list of people with similar food interests, thus providing an enhanced experience to users.

Other aspects, advantages and novel features of the present invention will become apparent from the detailed description of the invention when considered in conjunction with the accompanying drawings.

This Summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 depicts the generalized working view of the system in accordance with the embodiments of the invention.

FIG. 2 depicts another working view of the system in accordance with the embodiments of the invention.

The apparatus and method components have been represented where appropriate by conventional symbols in the drawings, showing only those specific details.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example, and without limitation, the programmable computer may be a mainframe computer, server, personal computer, laptop, personal data assistant, or cellular telephone. A program code is applied to input data to perform the functions described herein and generate output information. The output information is applied to one or more output devices, in known fashion.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device (e.g., ROM or magnetic diskette), readable by a general or special purpose programmable computer, for configuring and operating the computer when the computer reads the storage media or device to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer-readable medium that bears computer-usable instructions for one or more processors. The medium may be provided in various forms, including one or more diskettes, compact disks, tapes, chips, wireline transmissions, satellite transmissions, internet transmissions or downloading's, magnetic and electronic storage media, digital and analog signals, and the like. The computer-usable instructions may also be in various forms, including compiled and non-compiled code.

The invention is based on components of an exemplary environment in which the invention may be used. The online system has focused components and is based on simple to use. Further, the online web-based application allows one to connect with people with similar food cravings and have a good time with them. The user can also rate their experience anywhere from 1 to 5 stars. The user can also leave a short review about their interaction and experience.

The invention can be viewed and used from a personal computer, laptop, PDA or any computing device. To use the web-based application the user has to be connected to internet to use services in real time. For real time utility needs to be connected to internet through local area networks (“LANs”)/wide area networks (“WANs”), wireless network or independent internet source. Further, the internet would connect the user to the online feedback application server, through the user's computing or mobile device, where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Client device may include a browser application that is configured to receive and to send web pages, web-based messages, and the like. The browser application may be configured to receive and display graphics, text, multimedia, and the like, employing virtually any web-based language, including Standard Generalized Markup Language (SMGL), HyperText Markup Language (HTML), and so forth.

Client devices may also include mobile computing devices, especially the smartphones, which allow the user to download the application and use it on one click. The online website has a responsiveness mode for the application to function in full on the mobile computing device. Any mobile computing device can be used by the user for using the application. Such devices include portable devices such as, cellular telephones, smartphones, Personal Digital Assistants (PDAs), handheld computers, wearable computers, tablet computers, integrated devices combining one or more of the preceding devices, and the like.

EatChat is a user-friendly online application designed to help individuals make informed and healthy food choices. The application is easily accessible through its website or a mobile app, which can be downloaded from the Google Play store for free. For those who use iOS devices, the app is also available on the Apple App Store.

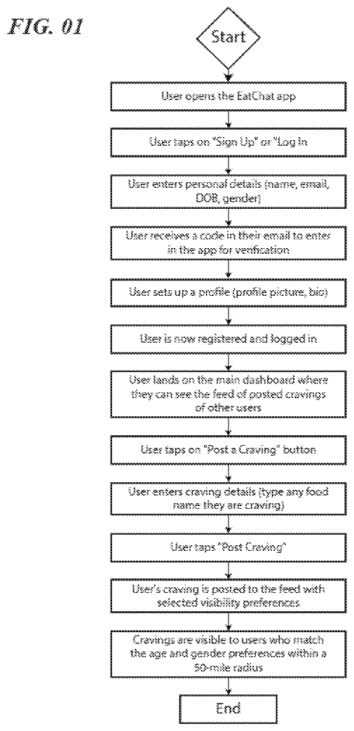

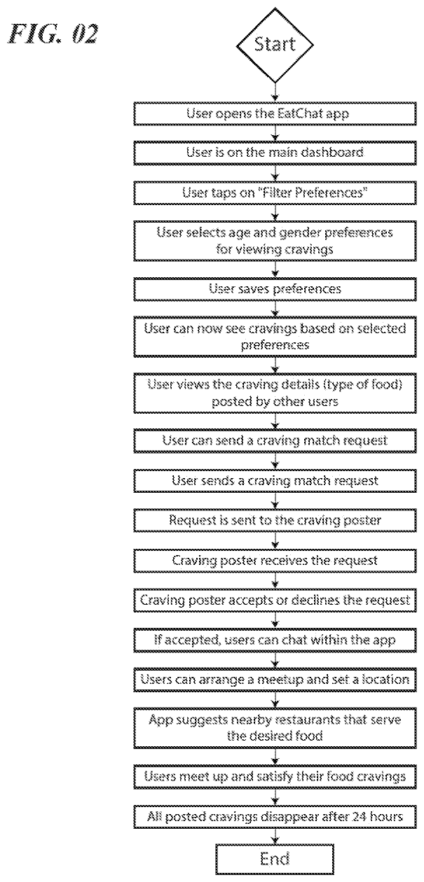

The working of the system can be understood by FIG. 1 and FIG. 2 which are detailed below. The application is intuitive and easy to navigate, making it accessible to users of age 18 and above.

Ideally, the system of the present invention also works as a social network or community platform for restaurants, users, and the community. The system allows a business owner to create a page about the restaurant or a chef to create a page about themselves on the system. The business owner or chef could upload information from a computer, smart phone, or other Wi-Fi or Internet browsing technologies. Further, the business owner or chef could post such information as menus, daily specials, head chefs, and the like, and change such information at anytime from anywhere, utilizing a computer, smart phone, or other Wi-Fi or Internet browsing technology. Each page could be changed and updated daily, if desired. Additionally, prospective patrons can link to maps and/or directions, including 360-degree views of the desired restaurant location.

An additional aspect of the present invention is the ability for users to identify or establish queues for restaurants, chefs, or dishes they want to try. Utilizing the restaurant search guide and available information including reviews and ratings, a user can search for restaurants. The queues would also show additional information, which might include ratings, type of restaurant, latest review, reviewer, cost, availability, and top menu selections or dishes.

Additionally, upon user registration, as needed to obtain the maximum value from the system, users can create a profile. Through interaction of the site, answers to profile questions regarding likes and dislikes, search history, ratings, and reviews base profile is created. This also involves a process for generating recommendations of restaurants, chefs, or dishes provided. Initially, a user's profile or preferences are identified from information provided by the user such as information that might come from various questions or surveys to identify a user's likes, dislikes, and preferences. The first time the user goes through the process the system tabulates and creates the user's preference profile.

The system also allows users to connect to people within a specified area limit (a 50-mile radius) and can connect with them through the real-time chat option. The interacting users can decide to meet at the same eating outlet and can have an enhanced experience of eating the food they are craving together as new friends.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method to be performed by a computer for operating a matching service comprising:
generating, from empirical data, a number of factors corresponding to a like number of functions of one or more variables relevant to relationship satisfaction;
approximating the satisfaction that a user of the matching service based on food cravings and has in the relationships that the user forms with others; and,
identifying, with the other user for a meetup plan at a location like the first user.
The system as per claim 1, wherein the user can register on the platform.
The system as per claim 1, wherein the registration process involves entering personal details including but not limited to name, email, DOB, and gender.
The system as per claim 1, wherein the user can setup a profile picture and complete the registration.
The system as per claim 1, wherein the user lands on the main dashboard and can see the feed of posted cravings of other users.
The system as per claim 1, wherein the user can post to the feed with selected visibility preferences.
The system as per claim 1, wherein through the pre-trained algorithms, cravings are visible to users who match the age and gender preferences within a 50-mile radius.

2. A system of matching the user with another user having the same food preferences wherein:
The system as per claim 2, wherein the user can tap on “Filter Preferences”.
The system as per claim 2, where in the user can save their age and gender preferences to match with.
The system as per claim 2, wherein the user can save their food presence.
The system as per claim 2, wherein the user can see cravings based on selected preferences for viewing cravings.
The system as per claim 2, wherein the user can send a craving match request.
The system as per claim 2, wherein the user sends a craving match request.
The system as per claim 2, wherein the request is sent to the craving poster.
The system as per claim 2, wherein the craving poster receives the request, and the craving poster can accept or decline the request.
The system as per claim 2, wherein the accepted user can chat within the app and can arrange a meetup location (restaurant).
The system as per claim 2, wherein the users can meetup and satisfy their food craving.
